(19) United States
(12) Patent Application Publication
(10) Pub. No.: US 2006/0114404 A1
(43) Pub. Date: Jun. 1, 2006

(54) Spacer and liquid crystal display panel using the same

(76) Inventors: Jung-Hsiang Lin, Taichung City (TW); Jen-Lang Tung, Kaohsiung City (TW); Hao-Yu Chang, Jhubei City (TW)

Correspondence Address: RABIN & Berdo, PC, 1101 14TH STREET, NW, SUITE 500, WASHINGTON, DC, 20005, US

(21) Appl. No.: 11/107,788

(22) Filed: Apr. 18, 2005

(30) Foreign Application Priority Data
Nov. 29, 2004 (TW) 93136800

(51) Int. Cl. G02F 1/1339

(52) U.S. Cl. 349/156

(57) ABSTRACT

A spacer and a liquid crystal display panel using the same are provided. The spacer is located between a first substrate and a second substrate. The spacer includes a bottom portion and a neck portion. The bottom portion is disposed on the first substrate. The neck portion is disposed on the bottom portion. The contact area between the neck portion and the bottom portion is smaller than that between the bottom portion and the first substrate.

This application claims the benefit of Taiwan application Serial No. 93136800, filed Nov. 29, 2004, the subject matter of which is incorporated herein by reference.

### BACKGROUND OF THE INVENTION

1. Field of the Invention

The invention relates in general to a spacer of liquid crystal display panel and a manufacturing thereof, and more particularly to a compression resistant spacer of the display panel and a manufacturing method thereof.

2. Description of the Related Art

Liquid crystal display (LCD) panel has replaced conventional CRT monitor and become the mainstream display product. The structure of a liquid crystal display panel mainly comprises two glass substrates assembled in pair, allowing liquid crystals to be infused into the space formed between the two glass substrates.

Currently, one drop filling (ODF) method is often used in the manufacturing process of infusing liquid crystal into the liquid crystal display panel. In the ODF manufacturing process, firstly, the surface of a TFT substrate or a color filter substrate is applied with sealant. Next, under a vacuum environment, the liquid crystal drips onto the surface of the TFT substrate or the color filter substrate, which has been applied with sealant, for the liquid crystal to be evenly distributed over the region enclosed by the sealant. Then, the TFT substrate and the color filter substrate are assembled in pair. After that, a normal barometric pressure is resumed and is used to assemble the TFT substrate and the color filter substrate to form a liquid crystal display panel. The color filter substrate or the TFT substrate has a spacer thereon, wherein the spacer provides a cell gap between the TFT substrate and the color filter substrate following the assembly of the TFT substrate and the color filter substrate, so that the liquid crystal can be distributed between the TFT substrate and the color filter substrate.

In the method of infusing the liquid crystal, if the amount of the liquid crystal does not go with the height and the design of the spacer, vacuum bubbles would occur. Under a high temperature, visual defects are likely to occur due to an uneven cell gap between two substrates and is caused by the expansion of liquid crystal. Therefore, the design of increasing the flexibility of the spacer is conducive to the cooperation between the amount of the liquid crystal and the cell gap; thereby the above-mentioned problems are resolved.

For current color filters with photo spacer, the easiest way to get flexibility behavior is reduce the ratio of photo spacer. However, conventional photo spacer design with low ratio has a poor resistance to compression, so the liquid crystal display panel would easily be damaged by a large external force, hence the faulty rate increasing.

### SUMMARY OF THE INVENTION

The object of the invention is to provide a spacer which is flexible during the manufacturing process of liquid crystal infusing to facilitate an appropriate association between the amount of liquid crystal and cell gap, furthermore, after TFT substrate and color filter substrate are assembled in pair, the spacer is compression resistant to the pressure applied onto the liquid crystal display panel by an external force, wherein the spacer can be a photo spacer or made of photoresist material.

According to an object of the invention, a spacer for a liquid crystal module disposed between a first substrate and a second substrate is provided. The spacer comprises a bottom portion and a neck portion. The bottom portion is adapted to be disposed on the first substrate. The neck portion is disposed on the bottom portion. The contact area between the neck portion and the bottom portion is smaller than that between the bottom portion and the first substrate.

According to another object of the invention, a liquid crystal display panel is provided. The display panel includes a first substrate, a second substrate and a spacer. The spacer comprises a bottom portion and a neck portion. The bottom portion is adapted to be disposed on the first substrate. The neck portion is disposed on the bottom portion. The contact area between the neck portion and the bottom portion is smaller than that between the bottom portion and the first substrate.

In one embodiment of the invention, the bottom portion is disposed on part of the first substrate. The neck portion is disposed on the top surface of the bottom portion. The spacer includes a photo spacer. The spacer can be formed into a single body. For example, the spacer, having the bottom portion and a neck portion, may be formed on the first substrate or the second substrate by performing a half-tone masking process. The first substrate and the second substrate are respectively a color filter substrate and a thin film transistor substrate. In other embodiment of the invention, the second substrate and the first substrate are respectively a color filter substrate and a thin film transistor substrate.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a sectional view showing the status prior to the assembly of two substrates of the liquid crystal display panel according to a first embodiment of the invention;

FIG. 1B is a sectional view showing the status after the assembly of two substrates of the liquid crystal display panel of FIG. 1A;

FIG. 2 is a sectional view showing the status prior to the assembly of two substrates of the liquid crystal display panel according to a second embodiment of the invention;

FIG. 3 is a sectional view showing the status prior to the assembly of two substrates of the liquid crystal display panel according to a third embodiment of the invention;

FIG. 4A is a sectional view showing the status when a neck portion contacts a bottom portion and a second substrate at the same time;

FIG. 4B is a sectional view showing the status when two neck portions contact a second substrate at the same time;

FIG. 5 is a flowchart of the formation of a spacer;

FIG. 6 is a flowchart of a manufacturing method of a liquid crystal display; and

FIG. 7 is an external force response curve of the spacer.

### DETAILED DESCRIPTION OF THE INVENTION

### First Embodiment

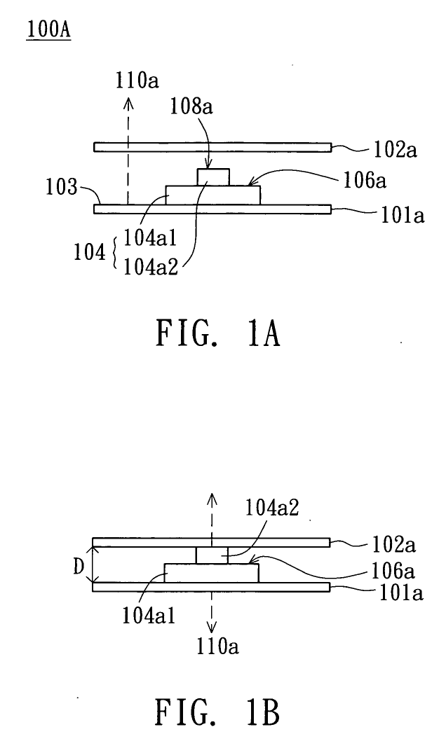

Referring to FIG. 1A, a sectional view showing the status prior to the assembly of two substrates of the liquid crystal display panel according to a first embodiment of the invention is sown. In FIG. 1A, liquid crystal display panel 100A comprises a first substrate 101a, a second substrate 102a and a spacer 104. The spacer 104 is disposed between the first substrate 101a and the second substrate 102a, so that a cell gap (unshown) is formed between the first substrate 101a and the second substrate 102a. The spacer 104 comprises a bottom portion 104a1 and a neck portion 104a2. The bottom portion 104a1 is disposed between the first substrate 101a and the second substrate 102a. The neck portion 104a2 is disposed between the bottom portion 104a2 and the second substrate 102a. The contact area between the neck portion 104a2 and the bottom portion 104a1 is smaller than that between the bottom portion 104a1 and the first substrate 101a.

In this embodiment of the invention, the bottom portion 104a1 is disposed on part of the first substrate 101a and has a top surface 106a. The neck portion 104a2 is disposed on part of the top surface 106a of the bottom portion and has a top surface 108a. The top surface 108a abuts against part of the second substrate 102a when the first substrate 101a and the second substrate 102a are assembled in pair. The spacer 104 can be a photo spacer, and the bottom portion 104a1 and the neck portion 104a2 can be formed in one piece. The first substrate 101a and the second substrate 102a respectively can be a thin film transistor (TFT) substrate and a color filter substrate, or respectively can be the color filter substrate and the TFT substrate.

Referring to FIG. 1B, a sectional view showing the status after the assembly of two substrates of the liquid crystal display panel of FIG. 1A is shown. When the first substrate 101a and the second substrate 102a are assembled in pair, the spacer 104 provides a cell gap D between the first substrate 101a and the second substrate 102a. The contact area between the neck portion 104a2 and the second substrate 102a is smaller than that between the bottom portion 104a1 and the first substrate 101a. The contact area between the neck portion 104a2 and the second substrate 102a is substantially equal to that between the neck portion 104a2 and the bottom portion 104a1.

In FIG. 1A, the first substrate 101a has a normal 110a extending from a surface 103 of the first substrate 101a facing the second substrate 102a. Any cross sectional area of the neck portion 104a2 perpendicular to the normal 110a is smaller than any cross sectional area of the bottom portion 104a1 perpendicular to the normal 110a. Moreover, the neck portion 104a2 is disposed anywhere on the top surface 106a of the bottom portion 104a2. In the present embodiment, the neck portion 104a2 is disposed at the center of the top surface 106a of the bottom portion 104a2.

When the first substrate 101a and the second substrate 102a receive a first external force after having been assembled in pair, the cross sectional area of the neck portion 104a2 is smaller than that of the bottom portion 104a1, so the neck portion 104a2 would receive a larger pressure and have a larger amount of compression than the bottom portion 104a1. Meanwhile, another part of the top surface 106a of the bottom portion 104a1 does not contact the second substrate 102a.

When the first substrate 101a and the second substrate 102a receive a second external force, which is larger than the first external force, after having been assembled in pair, the amount of compression of the neck portion 104a2 continues to increase until the top surface 106a of the bottom portion 104a1 contacts the second substrate 102a. Meanwhile, there would have a large increase in total compressed area.

When the first substrate 101a and the second substrate 102a receive a third external force, which is larger than the second external force, after having been assembled in pair, the top surface 106a of the bottom portion 104a1 contacts the second substrate 102a. After that, the compression rate and the amount of compression of the spacer 104 are far smaller than that in the event when the bottom portion 104a1 does not contact the second substrate 102a. Because of a much larger cross sectional compressed area after the top surface 106a of the bottom portion 104a1 contacts the second substrate 102a, the spacer 104 are substantially not compressed significantly.

Any skilled in the art will know the invention is not limited in the above-mentioned description. For example, the bottom portion 104a1 and the neck portion 104a2 include respectively different materials. In one embodiment, the hardness of the neck portion 104a2 is larger than the hardness of the bottom portion 104a1. In other embodiment, the hardness of the neck portion 104a2 is smaller than the hardness of the bottom portion 104a1.

### Second Embodiment

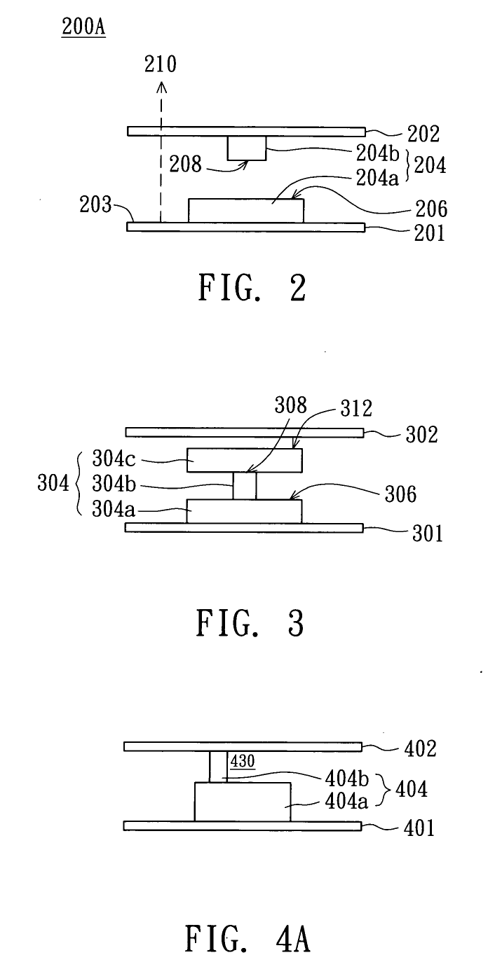

Referring to FIG. 2, a sectional view showing the status prior to the assembly of two substrates of the liquid crystal display panel according to a second embodiment of the invention is shown. In FIG. 2, liquid crystal display panel 200A comprises a first substrate 201, a second substrate 202 and a spacer 204. The spacer 204 comprises a bottom portion 204a and a neck portion 204b. The bottom portion 204a is disposed on part of the first substrate 201 and has a top surface 206. The bottom portion 204a can be a photo spacer. The neck portion 204b can be any protrusion area in the second substrate 202. Second substrate 202 may be a thin film transistor substrate or a color filter substrate. The neck portion 204b is disposed on part of the second substrate 202 and has a bottom surface 208. Part of the bottom surface 208 of the neck portion 204b abuts against part of the top surface 206 of the bottom portion 204a when the first substrate 201 and the second substrate 202 are assembled in pair. The spacer 204 can be formed into a single body. For example, the spacer 204, having the bottom portion 204a and a neck portion 204b, may be formed on the first substrate 201 or the second substrate 202 by performing a half-tone masking process.

When the first substrate 201 and the second substrate 202 are assembled in pair, the spacer 204 provides a cell gap (unshown) between the first substrate 201 and the second substrate 202.

The first substrate 201 has a normal 210 extending from the surface 203 of the first substrate 201 facing the second substrate 202. Any cross sectional area of the neck portion 204b perpendicular to the normal 210 is smaller than any cross sectional area of the bottom portion 204a perpendicular to the normal 210.

When the first substrate 201 and the second substrate 202 receive a first external force after having been assembled in pair, part of the top surface 206 that contacts the bottom surface 208 is compressed, while the rest part of the top surface 206 that does not contact the bottom surface 208 is almost not compressed and does not contact the surface of the second substrate 202.

When the first substrate 201 and the second substrate 202 receive a second external force, which is larger than the first external force, after having been assembled in pair, part of the top surface 206 that contacts the bottom surface 208 can be compressed until the rest part of the top surface 206 just contacts the surface of the second substrate 202.

When the first substrate 201 and the second substrate 202 receive a third external force, which is larger than the second external force, after having been assembled in pair, the rest part of the top surface 206 contacts the surface of the second substrate 202. Meanwhile, the compressed area of the spacer 204 increases largely, the bottom portion 204a and the neck portion 204b are almost not being compressed. In the second embodiment, since the cross sectional area of the bottom portion 204a is larger than that of the neck portion 204b, the deformation of the spacer 204 is mainly due to the neck portion 204b and partly due to the bottom portion 204a. Alternatively, the bottom portion 204a and the neck portion 204b can be made of different materials. For example, the hardness of the neck portion 204b is larger than that of the bottom portion 204a, i.e., the neck portion 204b is almost not compressed, and the compression or deformation is mainly received by or caused by the contact area of bottom portion 204a. For example, the bottom portion of spacer 204a can be a photo spacer. If second substrate 202 is thin film transistor substrate, the neck portion 240b can be any protrusion area in thin film transistor substrate as metal line . . . etc. If second substrate 202 is color filter, the neck portion 240b can be any protrusion area in color filter substrate. In other embodiment, the hardness of the neck portion 204b is smaller than that of the bottom portion 204a.

### Third Embodiment

Referring to FIG. 3, a sectional view showing the status prior to the assembly of two substrates of the liquid crystal display panel according to a third embodiment of the invention is shown. The spacer 304 is disposed between the first substrate 301 and the second substrate 302. Unlike the first embodiment, the third embodiment further comprises an auxiliary portion 304c disposed on the neck portion 304b in addition to the bottom portion 304a and the neck portion 304b. The bottom portion 304a, the neck portion 304b and the auxiliary portion 304c respectively have a top surface 306, a top surface 308 and a top surface 312. The spacer 304 can be a photo spacer. The bottom portion 304a, the neck portion 304b and the auxiliary portion 304c can be formed in one piece. The cross sectional area of the neck portion 304b is smaller than that of the bottom portion 304a. The cross sectional area of the auxiliary portion 304c can either be larger or smaller than that of the neck portion 304b. When an external force is applied onto the spacer 304, the bottom portion 304a, the neck portion 304b and the auxiliary portion 304c are respectively deformed to resist the external force. The bottom portion 304a, the neck portion 304b and the auxiliary portion 304c can have different hardness. For example, the hardness of the bottom portion 304a can be larger than that of the neck portion 304b and that of the auxiliary portion 304c, or the hardness of the bottom portion 304a can be smaller than the hardness of the neck portion 304b and that of the auxiliary portion 304c, or other arrangements.

### Fourth Embodiment

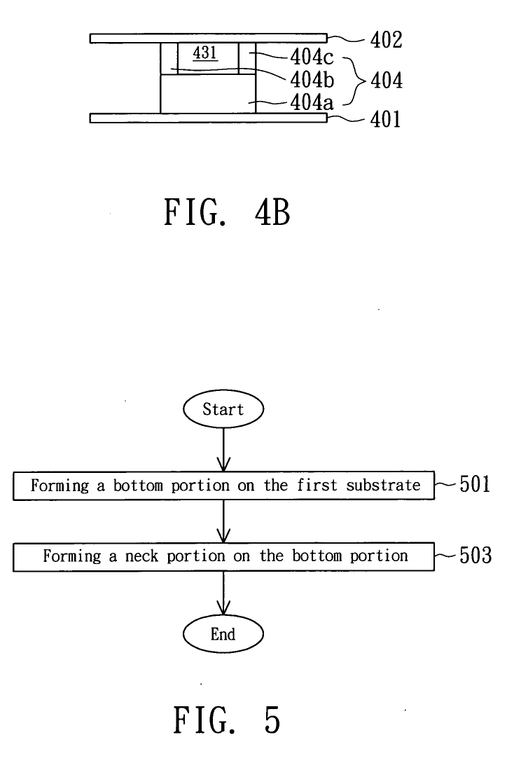

Referring to FIG. 4A and FIG. 4B, the spacer 404a can be a photo spacer, which further comprises a neck portion 404c, a neck portion 404b. The behavior of spacer under external loading is similar as second embodiment except multi-neck portion.

### Fifth Embodiment

Referring to FIG. 5, a manufacturing flowchart of a spacer is shown. Firstly, the method begins at step 501: a bottom portion 104a1 is formed on a first substrate 101a. Lastly, proceed to step 503: a neck portion 104a2 is formed on a bottom portion 104a1. The contact area between the neck portion 104a2 and the bottom portion 104a1 is smaller than that between the bottom portion 104a1 and the first substrate 101a.

### Sixth Embodiment

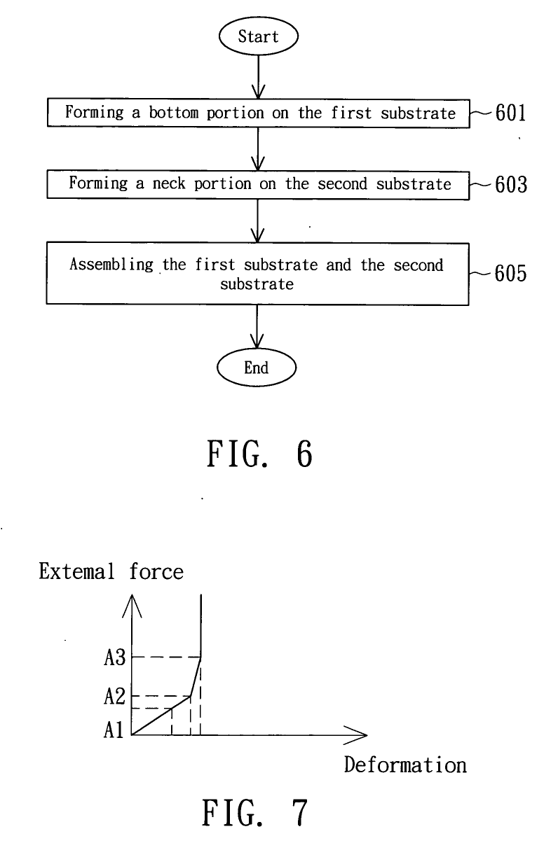

Referring to FIG. 6, a manufacturing flowchart of a liquid crystal display panel is shown. Firstly, the method begins at step 601: a bottom portion 204a is formed on a first substrate 201. Next, proceed to step 603: a neck portion 204a is formed on a second substrate 202. Lastly, proceed to step 605: the first substrate 201 and the second substrate 202 are assembled in pair. The contact area between the neck portion 204b and the bottom portion 204a is smaller than that between the bottom portion 204a and the first substrate 201.

Referring to FIG. 7, a relative curve between the external force applied on the spacer and the deformation of the spacer is shown. In the relative curve, the y-axis represents external force applied on the spacer, and the x-axis represents the deformation of the spacer. A1 represents a first force applied on the spacer, A2 represents a second force applied on the spacer, and A3 represents a third force applied on the spacer. It can be known from the drawings that the third force A3 is larger than the second force A2, and that the second force A2 is larger than the first force A1. Before the second force A2 is applied onto the spacer, the spacer has a linear deformation. When the force applied on the spacer equals A2, most area of the spacer contacts the opposite substrate. Because the area of the spacer receiving the stress when the stress exceeds the second force A2 is far larger than the area of the spacer receiving the stress when the force is smaller than A2, so that the increase in deformation is reduced sharply and a non-linear deformation curve id formed. When the structure of the spacer disclosed in the second embodiment, the third embodiment and the fourth embodiment receives the first force A1, part of the portion is compressed and forms a linear deformation. When the received force is smaller than the second force A2, the area of the spacer resisting the force does not change, resulting in a linear compression deformation. Since the area of part of the bottom portion that does not contact the neck portion is far larger than the area of the other part of the bottom portion that contacts the neck portion, in the event of having an force larger than the second force A2 and having a large increase in loading area of the spacer, there would not be any significant increase in deformation because the bottom portion has contacted the opposite substrate.

In a linear deformation range with sharp slope, the spacer is flexible, thereby avoiding the bubble on the liquid crystal display panel during the manufacturing process of liquid crystal infusing. The bubble is caused by vacuum void, and flexible spacer can change the internal volume of panel to match the volume of liquid crystal and avoid the vacuum void during the assembly process. Besides, after the TFT substrate and the color filter substrate are assembled in pair, when external pressure becomes larger and the deformation of the spacer exceeds the height of the neck portion, the cross section of the area that the bottom portion contacts the opposite substrate would be increased largely to resist the external force, stop the growth of deformation, and control the deformation of the spacer within a certain range, lest the spacer might over respond and generate plastic deformation, which would cause muras due to changes in the cell gap. The spacer disclosed in the above embodiments maintains the quality of liquid crystal display panel when receiving a large pressure and thus deformed.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A spacer for a liquid display module having a first substrate and a second substrate, comprising:
a bottom portion adapted to be disposed on the first substrate; and
a neck portion disposed on the bottom portion;
wherein the contact area between the neck portion and the bottom portion is smaller than that between the bottom portion and the first substrate.

2. The spacer according to claim 1, further comprising an auxiliary portion disposed between the neck portion and the second substrate.

3. The spacer according to claim 1, wherein the neck portion has an auxiliary portion adapted to contact with the second substrate.

4. The spacer according to claim 1, wherein the bottom portion and the neck portion are of different hardness.

5. The spacer according to claim 4, wherein the hardness of the neck portion is larger than the hardness of the bottom portion.

6. The spacer according to claim 4, wherein the hardness of the neck portion is smaller than the hardness of the bottom portion.

7. The spacer according to claim 1, wherein the first substrate has a normal extending from the bottom surface facing the second substrate, and any cross sectional area of the neck portion perpendicular to the normal is smaller than any cross sectional area of the bottom portion perpendicular to the normal.

8. The spacer according to claim 1, wherein the bottom portion and the neck portion are made of photoresist material.

9. A liquid crystal display panel comprising:
a first substrate;
a second substrate; and
a spacer disposed between the first substrate and the second substrate, comprising:
a bottom portion adapted to be disposed on the first substrate; and
a neck portion disposed on the bottom portion, wherein the contact area between the neck portion and the bottom portion is smaller than that between the bottom portion and the first substrate.

10. The liquid crystal display panel according to claim 9, wherein the spacer further comprises an auxiliary portion disposed between the neck portion and the second substrate.

11. The liquid crystal display panel according to claim 9, wherein the neck portion has an auxiliary portion adapted to contact with the second substrate.

12. The liquid crystal display panel according to claim 9, wherein the bottom portion and the neck portion are of different hardness.

13. The liquid crystal display panel according to claim 12, wherein the hardness of the neck portion is larger than that of the bottom portion.

14. The liquid crystal display panel according to claim 12, wherein the hardness of the neck portion is smaller than that of the bottom portion.

15. The liquid crystal display panel according to claim 9, wherein the first substrate has a normal extending from the bottom surface facing the second substrate, and any cross sectional area of the neck portion perpendicular to the normal is smaller than any cross sectional area of the bottom portion perpendicular to the normal.

16. The liquid crystal display panel according to claim 9, wherein the spacer is made of photoresist material.

17. The liquid crystal display panel according to claim 9, wherein the spacer is formed into a single body.
